(19) United States
(12) Patent Application Publication
(10) Pub. No.: US 2014/0032507 A1
(43) Pub. Date: Jan. 30, 2014

(54) DE-DUPLICATION USING A PARTIAL DIGEST TABLE

(71) Applicants: Douglas L. Voigt, Boise, ID (US); Siamak Nazari, Mountain View, CA (US)

(72) Inventors: Douglas L. Voigt, Boise, ID (US); Siamak Nazari, Mountain View, CA (US)

(21) Appl. No.: 13/558,388

(22) Filed: Jul. 26, 2012

(51) Int. Cl. G06F 7/00; G06F 17/30

(52) U.S. Cl. 707/692; 707/E17.002

(57) ABSTRACT

Data de-duplication is done on a data set. The data de-duplication is done using a partial digest table. Some digests are selective removed from the partial digest table when a pre-determined condition occurs.

### BACKGROUND

Data may contain duplicated information. For example, a text document may have multiple revisions stored on disk. Each revision may contain sections or pages that did not change between revisions. The data in storage may be reduced by only storing the unchanged sections or pages once, and placing a reference to the stored section in the other documents where the duplicate section occurred. This type of data storage is typically called de-duplication. Data de-duplication can be done as the data is stored or can be done to data that is already in storage.

When data is de-duplicated the data is divided into chunks and each chunk is hashed. If the hash has never been seen before the hash is stored in a hash table and the data for that chunk is stored. If the hash for the current chunk is already in the hash table, a copy of a chunk containing the identical data is already in storage. Therefore only a reference to the previously stored data is stored. Using this method only a single copy of each chunk of data is kept in storage.

When large quantities of data are de-duplicated, large numbers of chunks are generated. For example, using a chunk size of 4 Kbytes and storing 4 Tera-bytes (Tbytes) of data would generate 1×10⁹ hashes. Assuming each hash and its related metadata require 64 bytes, a total of 64 Gbytes of storage would be required to store the hash table, assuming no duplication. The de-duplication engine typically requires random access to the hash table. Therefore a typical de-duplication engine uses a combination of hard disk drive (HDD) and random access memory (RAM) to store the hash table.

### BRIEF DESCRIPTION OF THE DRAWINGS

FIG. 1 is an example computer system.

FIG. 2 is an example block diagram showing the de-duplication process for a virtual data set.

FIG. 3 is another example block diagram showing the de-duplication process for a virtual data set.

FIG. 4 is an example block diagram showing the de-duplication process for a physical data set.

### DETAILED DESCRIPTION

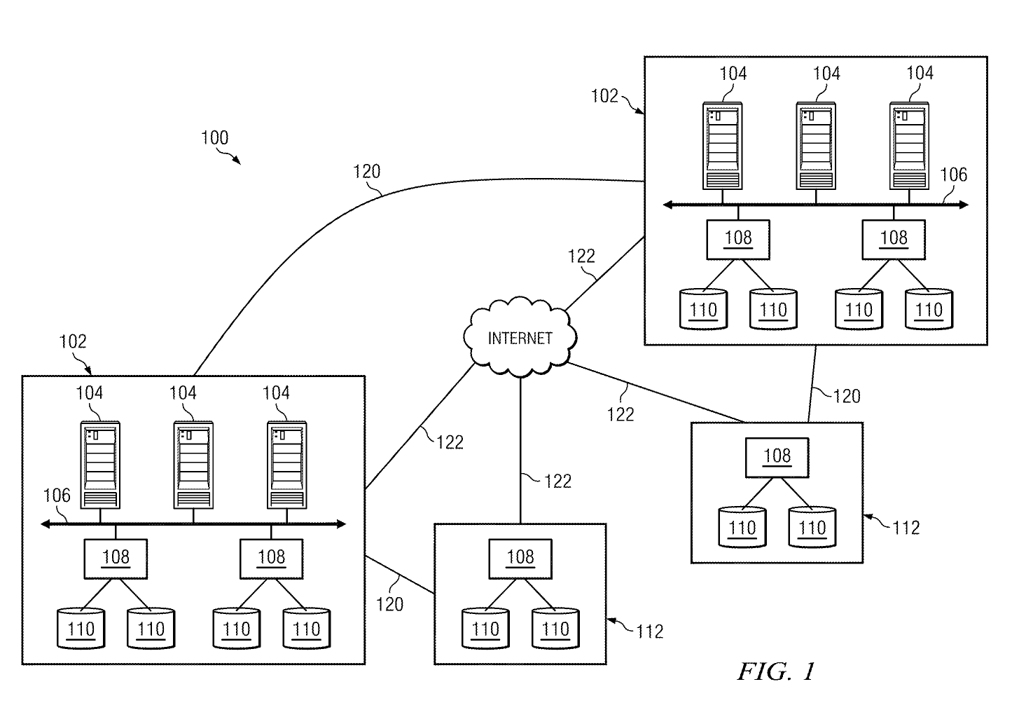

FIG. 1 is an example computer system. Computer system 100 comprises one or more data centers 102. Each data center 102 may contain one or more processors 104, an interlinking bus or fabric 106, one or more storage controllers 108, and one or more non-volatile storage devices 110. Processors 104 may comprise one or more central processing units (CPU's), one or more servers, micro-computers, blades, super computers, or the like. Processors 104 may also comprise random access memory (RAM), cache memory, and the like. Processors 104 and storage controllers 108 are coupled together through the interlinking bus or fabric 106. Interlinking bus or fabric 106 may be any type of link used to couple two or more devices together to form a SAN, for example a parallel bus, point-to-point links, optical links, or the like.

Each storage controller 108 is coupled to one or more non-volatile storage devices 110. Non-volatile storage devices 110 may include hard disk drives, optical drives, magneto-optical drives, tape drives, non-volatile random access memory (NVRAM), and the like. Each storage controller 108 may have storage controller software running on the storage controller 108. The storage controller software may be configured to control the storage of data to the physical devices attached to the storage controller 108. In another example, storage controllers 108 may be implemented as software running on a server, or as a combination of an input/output (I/O) card and software. The storage controller software contains a de-duplication engine (DDE) software module, that when executed by a processor, causes the DDE to de-duplicate data sets. In other examples, the DDE may be a combination of hardware and software.

The storage controller software may be stored as computer readable instructions, such as programming code or the like, in a non-transitory computer readable medium. For example, the non-transitory, computer-readable medium may include one or more of a non-volatile memory, a volatile memory, and/or one or more storage devices. Examples of non-volatile memory include, but are not limited to, electrically erasable programmable read only memory (EEPROM) and read only memory (ROM). Examples of volatile memory include, but are not limited to, static random access memory (SRAM), and dynamic random access memory (DRAM). Examples of storage devices include, but are not limited to, hard disk drives, compact disc drives, digital versatile disc drives, optical drives, and flash memory devices. The non-transitory computer readable medium, may be on the storage controller 108, the processor 104, one or more of the non-volatile storage devices 110, or the like.

Computer system 100 may also comprise one or more remote storage facilities 112. Remote storage facility 112 may comprise one or more memory controllers 108, and one or more non-volatile storage devices 110. Data centers 102 may be coupled to each other and to one or more remote storage facility 112. Data centers 102 may be coupled together with direct links 120 or coupled together with indirect links 122 through the internet as cloud services. Data centers 102 may be coupled to the remote storage facilities using a direct link 120 or using an indirect links 122 through the internet. The data centers 102 may be co-located or one data center may be located remotely from the other data center 102.

A user may be allocated storage space on a physical device in a data center 102, for example sectors on a hard drive, one or more hard drives, an array of hard drive, NVRAM or one or more tape drives. Or the use may be allocated storage space on a virtual device, or a combination of physical and virtual devices. When the user is allocated space on a physical devices the user accesses the data stored on storage devices 110 using the physical address of the storage devices 110. When the user has been allocated space on a virtual device the user accesses the data stored on storage devices 110 using the virtual address of the storage devices 110. The storage controllers maintain a mapping table that maps all the virtual addresses to physical addresses for each virtual device. The storage controllers 108 translate the virtual addresses to a physical address for the storage device 110 using the mapping table and then retrieves the data for the user.

During use a user may end up storing multiple copies of the same data onto the storage space they have been allocated. In one example of the present application, storage controller 108 will start a de-duplication engine (DDE) in the background that will locate and consolidate at least some of the duplicated data. The DDE may be computer executable instructions, stored in memory, that when executed by a processor, causes storage controller 108 to locate and consolidate the duplicate data. The DDE may be executed on a processor on the storage controller 108, or may be executed by processor 104, or on a combination of both the processor on the storage controller 108 and processor 104.

In one example, the de-duplication engine (DDE) will do de-duplication on data sets using a partial digest table or index. The partial digest table will be purged of some of the digest entries when the table becomes full, or after a predetermined number of chunks have been processed. The selection criteria for selecting the entries to be purged from the partial digest table may be based, in part, on the frequency that the chunks occur in the data set. The data de-duplication process may occur multiple times for each data set. The selection criteria for selecting the entries to be purged may change between the different de-duplication passes through the data set.

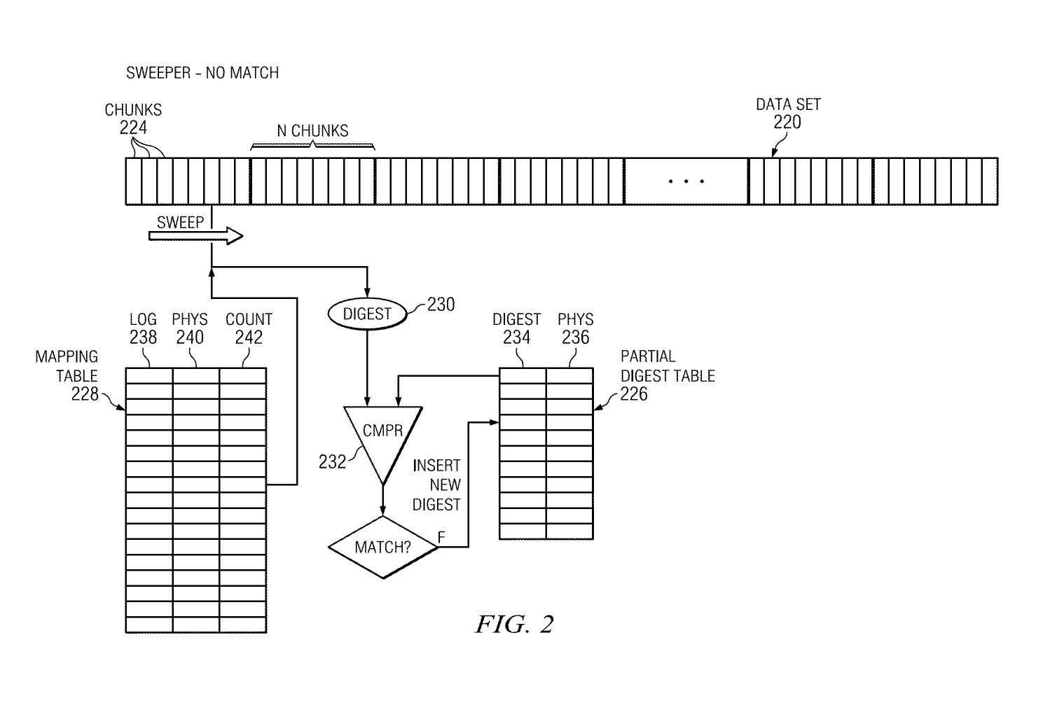

FIG. 2 is an example block diagram showing the de-duplication process for a virtual data set. The virtual data set 220 may be any set of data allocated to one or more users. In one example the virtual data set 220 may correspond to a container such as a 3PAR common provisioning group. The DDE uses a mapping table 228 to access the data in the virtual data set 220. Mapping table 228 has a list of logical addresses 238 with a corresponding physical address 240 and a count 242 associated with each physical address. Count 242 is the number of logical address that map to the same physical address. When the count reaches zero the physical address can be de-allocated for reuse.

To start the de-duplication process the DDE creates a partial digest table or empties a partial digest table that has already been created. In one example the partial digest table will contain a list of digests 234 with a corresponding physical address 236. In another example the partial digest table will contain a list of digests 234 with a corresponding logical address 236 (not shown). When storing a logical address with each digest the DDE would use the mapping table to obtain the corresponding physical address for a digest. In some examples the partial digest table will also contain a local count of the number of occurrences of a digest that map to the same corresponding physical address 236. The DDE divides the data set into chunks 224. The data can be divided into chunks 224 using a number of different methods or algorithms. Some chunking algorithms use fixed size chunks and other chunking algorithms, for example Two-threshold, two-divisor (TTTD), create variable sized chunks. The chunk 234 size shown in FIG. 2 has been chosen as a fixed size for clarity.

FIG. 2 shows the de-duplication process for when a match does not occur. The DDE sweeps through the chunks of data. The DDE uses mapping table 228 to acquire the physical address 240 of each chunk 224 from its logical address 238. As the DDE sweeps through the chunks of data a digest is generated for each chunk 230. The digest is typically a hash, but could also be a cyclic redundancy check (CRC). The digest is compared 232 to each of the digests already in the partial digest table 226. The controller may also search the partial digest index 226 for an entry that matches digest of the new chunk 230 using a more sophisticated search algorithm. For the digest generated for the first chunk 224 the table is empty, so the first digest is inserted into the partial digest table. When the digest for a chunk is not in the partial digest table, the digest is inserted into the table and the corresponding physical address is also added to the table. If the table contains a local count, the local count is set to 1.

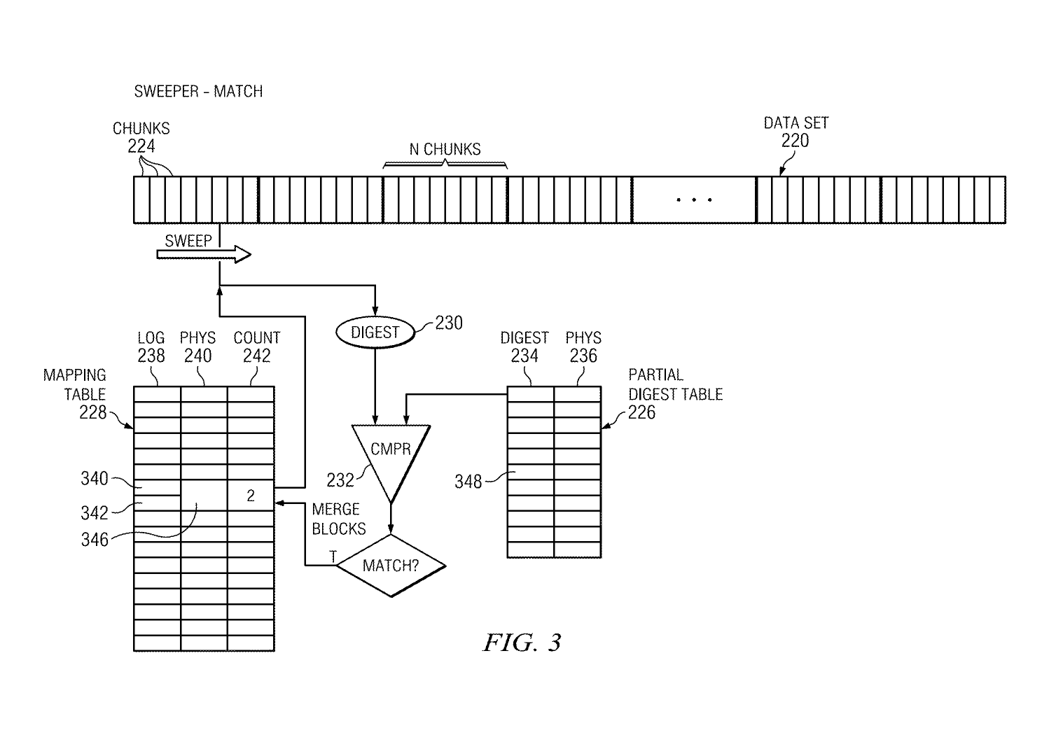

FIG. 3 is another example block diagram showing the de-duplication process for a virtual data set. FIG. 3 shows the de-duplication process when a match occurs. In FIG. 3 the digest 230 for the current chunk 224 of data has been generated. The digest 230 for the current chunk is compared to the digests in the partial digest table 226. In this case the digest 230 for the current chunk matches a digest 348 in the partial digest table 226. This means that the data corresponding to digest 230 is identical to the data corresponding to digest 248 (when using a hash as the digest).

The partial digest table remains unchanged when a match occurs if the table does not contain a local count. The mapping table 228 is used to merge the two logical addresses to point to the same physical address/chunk. This allows one of the two chunks in storage to be freed up for re-use (assuming the count for the chunk to be freed reaches zero). To merge the two logical addresses, the physical address of the current chunk is set equal to the physical address of the matching digest 348 using the information in the partial digest table. The count in the mapping table 228 corresponding to the physical address of the matching digest 348 is incremented by one. And the current chunk is freed up for re-use. When a local count is stored in the partial digest table, the local count for the matching entry is also incremented by one.

The partial digest table is of a limited size. The size is limited such that the partial digest table cannot hold all of the digests for all the chunks in the data set. The total number of digest entries in a full sized digest table is equal to the data set size divided by the chunk size, assuming a constant chunk size and no data duplication in the data set. For example when you have a chunk size of 16 Kbytes (16×10³ bytes) and your data set is 2 Terabytes (2×10¹² bytes) in size, the total number of entries in a full sized digest table would be 2×10¹² divided by 16×10³ which equals 1.25×10⁸ or 125 Million entries. If each entry in the table takes 256 bytes then the total digest table size is 256 times. 125×10⁹ which equals 32×10⁹ bytes or 32 Gigabytes. In this example the full sized digest table takes up approximately 1/64^{th} of the size of the data set (32 GBytes/2 TBytes).

The size for a partial digest table can be selected as a fixed size or may be a function of the data set size. When the partial digest table size is a function of the data set size, the partial digest table may be a smaller percentage of the data set size compared to a full sized digest table, or a percentage of the full sized digest table size. For example, a fixed sized partial digest table may be limited to 2 Gigabytes of data. For a table size dependent on the data set size the partial digest table may be limited to between 1/500th^{th} and 1/1500^{th} of the total data set size or 1/10^{th} to 1/20^{th} of the size of a full sized digest table. The size limit for the partial digest table can be adjusted dependent on the chunk size, the data set size, the full sized digest table size, available memory or some combinations of these numbers.

Because the size of the partial digest table is limited, the partial digest table can fill up before all the chucks have been checked. The partial digest table may be emptied when a pre-determined condition occurs. The pre-determined condition may be when a given number of chunks have been processed, when the partial table fills up, or when the number of entries in the table reaches a threshold number of entries, or some combination of these conditions. When the pre-determined condition occurs, the DDE does not completely empty the partial digest table, the DDE only removes some of the entries. When the pre-determined condition is met, the DDE selectively removes some of the table entries from the partial digest table.

The pre-determined condition can be changed during the de-duplication process through the data set or between data sets. For example, the first pre-determined condition for a data set may be selected such that the partial digest table is selectively emptied for the first time when the number of entries in the table reaches 80% of the table capacity. The second pre-determined condition for the data set may be selected such that the partial digest table is selectively emptied after only one chuck has been processed (i.e. causing the table to be checked after every chunk is processed). This would cause each digest to be removed after it had just been inserted, if it met the criteria for being selectively removed. This would be equivalent to discarding some digest before they were inserted into the table.

The DDE can select the entries to be removed from the partial digest table based on the count in the mapping table 228 maintained for the virtual data set. The count is the number of logical addresses that map to a single physical address in a given data set. Count is also a measure of the number of occurrences that a chunk is in the data set. A high count means that a chunk occurs frequently. A low count means that a chunk does not occur very often. In one example, the DDE will remove the entries from the partial digest table that have low count numbers. This preserves the entries in the table with high counts (i.e the chunks that have occurred frequently in the data set). When the partial digest table contains a local count, the DDE may use this local count to select the entries to remove from the partial digest table, or may use a combination of the local count and the count in the mapping table.

In other examples, the entries in the low end of the count range may be retained in the table. Because it is likely that the entries with high counts will re-occur (and be re-inserted into the table), removing them from the table allows less frequently occurring chunks to be de-duplicated. In other examples, the entries in the middle of the range of counts are retained in the partial digest table. For example, the DDE may remove entries with counts less than three and entries with counts greater than 10.

The DDE can selectively remove a fixed number of entries from the partial digest table or a variable number of entries from the partial digest table. A variable number may be removed when the entries below a threshold count are removed from the table. When removing a fixed number of entries, the fixed number may be a percentage of the total number of entries in the partial digest table, for example ½ the entries may be removed.

The de-duplication process may be done multiple times on the same data set. In some examples the criteria used to selectively remove entries from the partial digest table will be changed for each pass through the data set. For example, the first time de-duplication is done on a data set, the DDE may selectively remove the entries with high counts from the partial digest table. The second time de-duplication is done on the data set, the DDE may retain the entries in the middle of the range of counts from the partial digest table. And for a third pass through the data set, the DDE may retain the entries with low counts. The DDE may do the de-duplication passes through the data sets as a background process.

In another example, the DDE may use the count from the mapping table 228 to select the entries to retain during a first de-duplication pass. The DDE may use the local count from the partial digest table to select the entries to retain during a second de-duplication pass through the data set. The counts in the two tables may not match. When an entry is removed from the partial digest table and then the chunk re-occurs in the data set, the new entry in the partial digest table for that chunk will have its local count re-set to b 1. But the count in the mapping table doesn't get reset when an entry is removed from the partial digest table. The count in the mapping table 228 is the number of logical address that map to the same physical address measured across the entire data set. The local count in the partial digest table is the number of time the chunk has occurred while this entry has remained in the partial digest table.

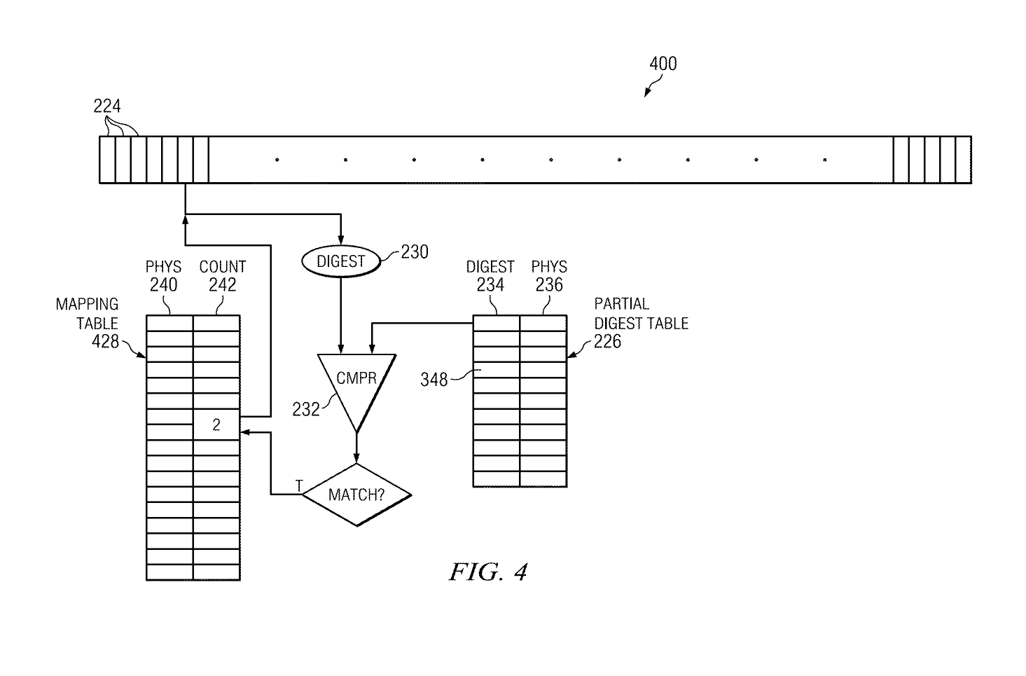

The examples above describe how data may be de-duplicated in a virtual data set. The data in a physical data set may also be de-duplicated. FIG. 4 is an example block diagram showing the de-duplication process for a physical data set. FIG. 4 shows the de-duplication process when a match occurs. The DDE uses mapping table 428 to acquire the physical address 240 of each chunk 230. This is done by locating the physical address whose offset into the mapping table equals the address of the chunk. As the DDE sweeps through the chunks of data a digest is generated for each chunk 230. The digest 232 is compared to each of the digests already in the partial digest table 226. In this case the digest 230 for the current chunk matches a digest 348 in the partial digest table 226. This means that the data corresponding to digest 230 is identical to the data corresponding to digest 348 (when using a hash as the digest).

The partial digest table remains unchanged when a match occurs if the table does not contain a local count. The mapping table 428 is used to merge the two physical addresses to point to the same chunk. This allows one of the two chunks in storage to be freed up for re-use. To merge the two addresses, the physical address of the current chunk is set equal to the physical address of the matching digest 348 using the information in the partial digest table. The count in the mapping table 428 corresponding to the physical address of the matching digest 348 is incremented by one. And the current chunk is freed up for re-use. When a local count is stored in the partial digest table, the local count for the matching entry is also incremented by one.

1. A method of de-duplicating data, comprising:
computer executable code, that when executed by a processor, performs the following steps:
dividing a data set into a plurality of chunks;
clearing a partial digest table before processing a first of the plurality of chunks;
processing each of the plurality of chunks by:
generating a digest for each of the plurality of chunks;
storing each digest that is not currently in the partial digest table into the partial digest table as well as a corresponding address for the chunk;
discarding each digest already stored in the partial digest table and freeing its corresponding chunk for re-use on a storage device;
selectively removing a subset of the digests from the partial digest table when a pre-determined condition occurs, wherein the subset of digests are removed using a first criteria.

2. The method of de-duplicating data of claim 1, wherein the partial digest table is a fixed size smaller than a size of a full digest table for the data set.

3. The method of de-duplicating data of claim 1, wherein the partial digest table has a size that is dependent on a size of the data set.

4. The method of de-duplicating data of claim 3, wherein the partial digest table has a size that is between 1/10^{th} to 1/25^{th} the size of a full digest table for the data set.

5. The method of de-duplicating data of claim 1, wherein the first criteria for selectively removing the subset of digests is based on a count of the number of times the chunk occurs in the data set.

6. (canceled)

7. The method of de-duplicating data of claim 1. wherein the pre-determined condition is selected from the group of conditions comprising: when a number of entries in the partial digest table passes a threshold number of entries, and when a pre-set number of chunks has been processed.

8. The method of de-duplicating data of claim 1, wherein the method of de-duplicating data is repeated a second time through the data set using a second criteria for selectively removing the subset of digests from the partial digest table when the pre-determined condition occurs, the second criteria different than the first criteria.

9. The method of de-duplicating data of claim 1, wherein the data set is a virtual data set.

10. A computer system comprising:
a processor;
a storage device coupled to the processor, the storage device storing at least one data set;
memory coupled to the processor, the memory containing computer readable instructions that, when executed by the processor cause a de-duplication engine (DDE) to perform de-duplication of the data set;
the DDE to divide the data set into a plurality of chunks;
the DDE to empty a partial digest table before processing a first of the plurality of chunks;
the DDE to process each of the plurality of chunks by:
generating a digest for each of the plurality of chunks;
storing each digest that is not currently in the partial digest table into the partial digest table as well as a corresponding address for the chunk;
discarding each digest already stored in the partial digest table and freeing its corresponding chunk for re-use on the storage device;
selectively removing a subset of the digests from the partial digest table when a pre-determined condition occurs, wherein the subset of digests are removed using a first criteria.

11. The computer system of claim 10, wherein the partial digest table is at least 10 times smaller than a size of a full digest table for the data set.

12. The computer system of claim 10, wherein the first criteria for selectively removing the subset of digests is based on the frequency the plurality of chunks occur in the data set.

13. The computer system of claim 10, wherein the first criteria for selectively removing the subset of the digests is to remove digests for chunks that occur infrequently.

14. The computer system of claim 10, wherein the pre-determined condition is selected from the group of conditions comprising: when a number of entries in the partial digest table passes a threshold number of entries, and when a pre-set number of chunks has been processed.

15. The computer system of claim 10, wherein the DDE repeats the de-duplication of the data set a second time using a second criteria for selectively removing the subset of digests from the partial digest table when the pre-determined condition occurs, the second criteria different than the first criteria.

16. The method of de-duplicating data of claim 5, wherein the first criteria for selectively removing the subset of digests is to remove digests having a subset of chunks from the plurality of chunks occurring more frequently than others of the plurality of chunks in the data set.

17. A method of de-duplicating data, comprising:
computer executable code, that when executed by a processor, performs the following steps:
clearing a partial digest table before processing a plurality of chunks of a data set, the partial digest table includes a list of digests with a corresponding address;
processing each of the plurality of chunks by:
generating a digest for each of the plurality of chunks;
storing each digest that is not currently in the partial digest table into the partial digest table as well as a corresponding address for the chunk;
discarding each digest already stored in the partial digest table and freeing its corresponding chunk for re-use on a storage device;
selectively removing a subset of the digests from the partial digest table when a pre-determined condition occurs, wherein the subset of digests are selected for removal using a first criteria, and wherein the subset includes fewer digests than all digests in the partial digest table.

18. The method of de-duplicating data of claim 16, wherein the partial digest table includes a local count of a number of occurrences of a digest that map to a same corresponding address.

19. The method of de-duplicating data of claim 16, further comprising merging two logical addresses by setting a physical address of a current chunk equal to a physical address of a matching digest using information in the partial digest table.

20. The method of de-duplicating data of claim 19, further comprising incrementing a count in a mapping table corresponding to a physical address of a matching digest, and freeing up a current chunk for re-use.

21. The method of de-duplicating data of claim 20, wherein a local count for a matching entry is incremented by one when a local count is stored in the partial digest table.
